(19) United States
(12) Patent Application Publication
(10) Pub. No.: US 2015/0068614 A1
(43) Pub. Date: Mar. 12, 2015

(54) CONDENSATE TRAP

(71) Applicant: Th. Witt Kaeltemaschinenfabrik Gmbh, Aachen (DE)

(72) Inventor: Titus Bartholomeus, HS Sittard (NL)

(21) Appl. No.: 14/250,772

(22) Filed: Apr. 11, 2014

Related U.S. Application Data
(63) Continuation of application No. PCT/NL2012/050712, filed on Oct. 11, 2012.

(30) Foreign Application Priority Data
Oct. 12, 2011 (NL) 2007585

(51) Int. Cl. F16T 1/14

(52) U.S. Cl. CPC F16T 1/14
USPC 137/197; 137/204

(57) ABSTRACT

A condensate trap is provided with a liquid supply hole and a liquid discharge hole, as well as a vapor discharge hole located in the upper side of the casing. A cylindrical chamber is located in the casing in which chamber an expansion piston can move. A hollow piston rod is attached to the lower side of the expansion piston. The liquid supply hole communicates with the chamber around the piston rod. The wall of the piston rod has throttling ports which extend in tangential direction. A siphon is located in the piston rod underneath the throttling ports. In the piston rod underneath the siphon is located a further throttling port, which can communicate with the liquid discharge hole when the expansion piston moves up. The space in a further chamber underneath the bottom of the piston rod communicates via a channel with the liquid discharge hole.

### RELATED APPLICATIONS

This application is a continuation of International application PCT/NL2012/050712 filed on Oct. 11, 2012 claiming priority from Dutch application NL 2007585 filed on Oct. 12, 2011, both of which are incorporated in their entirety by this reference.

### FIELD OF THE INVENTION

The invention relates to a condensate trap.

### BACKGROUND OF THE INVENTION

For discharging condensate to a lower pressure, many solutions are known in particular in the field of steam technology. If we restrict ourselves to the mechanical embodiments, they are subdivided into thermostatic, mechanical and thermodynamic condensate traps (condensate or steam traps). In industrial refrigeration engineering they are restricted to various highly reliable high pressure float gauge configurations. In essence the operation boils down to a float that opens a throttling port further when the liquid level rises (condensate level). FIG. 1 shows a typical application of this. Compressed cooling agent gas is condensed in a condenser 21 and received in a pressure vessel 22 (see FIG. 1). A float gauge 23 is mounted in this pressure vessel. The float gauge includes a float which is attached to a throttle valve 24 by means of a lever. The higher the liquid level the more condensate is allowed to pass. Allowing gas that is not yet compressed or inert gas is avoided by this concept. This is in contrast to the many other solutions that are used in steam technology. The expanded condensate now ends up in a combined drop separator/circulation vessel 25. In this vessel the gas developed during the throttling operation is separated from the liquid. The liquid which is in boiling state is now taken to evaporators 27 as a result of gravity (thermo siphon) or by means of a pump 26. The evaporated liquid and the excess liquid return to the vessel where the vapor is sucked away by a compressor 28 so as to be compressed again.

If one wants to make use of the energy that is released when condensate expands, there is a possibility to make use of a two-stage expansion. The released gas can then be used for driving an expander. In refrigerating engineering two-stage expansion is often utilized if screw compressors 29 are used (see FIG. 2). The expanded cooling agent ends up in a drop separator (economiser) 30 where the flash gas is separated from the liquid and is added drop-free to the screw compressor. This process enhances the cooling efficiency of the entire refrigerator plant. State of the art

For the expander driven pump described in patent application NL2006332 a similar two-stage expansion is needed. The above economizer system with its two float gauges and drop separator is too voluminous and thus expensive for this.

### BRIEF SUMMARY OF THE INVENTION

It is an object of the invention to provide a cost effective condensate trap for two stage expansion. For this purpose the condensate trap according to the invention is characterized in that it includes a casing that is provided with a liquid supply hole located in the side wall and a liquid discharge hole located in the side wall underneath the liquid supply hole, which casing accommodates a cylindrical chamber connecting to the liquid supply hole, in which chamber an expansion piston can be moved which has a hollow piston rod that is attached to its under side and which piston rod has an outside diameter that is smaller than the outside diameter of the expansion piston, while the liquid supply hole communicates with the chamber around the piston rod, and the wall of the piston rod has at least a single throttling port, and a siphon is located in the piston rod underneath the throttling port, which siphon communicates with the space in the piston rod via an open upper side and via an open lower side communicates with a space in the piston rod above the bottom of the piston rod, where a further throttling port is located in the wall of the piston rod underneath the upper side of the siphon and as a result of an upward displacement of the expansion piston can be made to communicate with the liquid discharge hole, while the space in a further chamber underneath the bottom of the piston rod communicates via a channel with the liquid discharge hole.

The solution found is an entirely new type of mechanical condensate trap and is based on the differences in mass flow if one expands (throttles) a medium at a certain, so- called critical, pressure difference. Beyond a certain, so-called critical pressure difference, choked flow will arise. The velocity in the keel of the throttling action is then the velocity of sound. The volume flow through the keel is fixed as a result. The mass flow as a result of the throttling action then only depends on the medium density when the throttling action is commenced.

An embodiment of the condensate trap according to the invention is characterized in that the throttling port extends in tangential direction of the piston rod. A further embodiment of the condensate trap according to the invention is characterized in that a vapor vent hole is located in the upper side of the casing.

### BRIEF DESCRIPTION OF THE DRAWINGS

The invention will be elucidated more fully hereinbelow based on an example of embodiment of the condensate trap according to the invention while reference is made to the appended drawings, in which:

FIG. 1 illustrates a known environment including a condenser;

FIG. 2 illustrates a further known environment including a condenser;

FIG. 3 illustrates an embodiment of a condensate trap according to the invention in longitudinal section;

FIG. 4 illustrates a cross section along line IV-IV of the condensate trap shown in FIG. 3; and

FIG. 5 illustrates a cross section along line V-V of the condensate trap shown in FIG. 3.

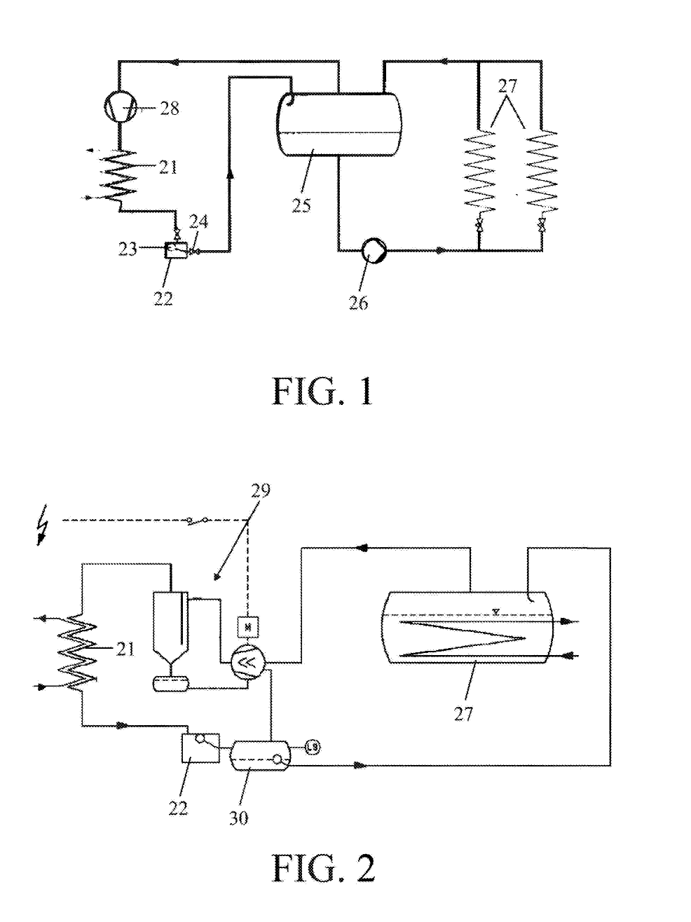

### DETAILED DESCRIPTION OF THE INVENTION

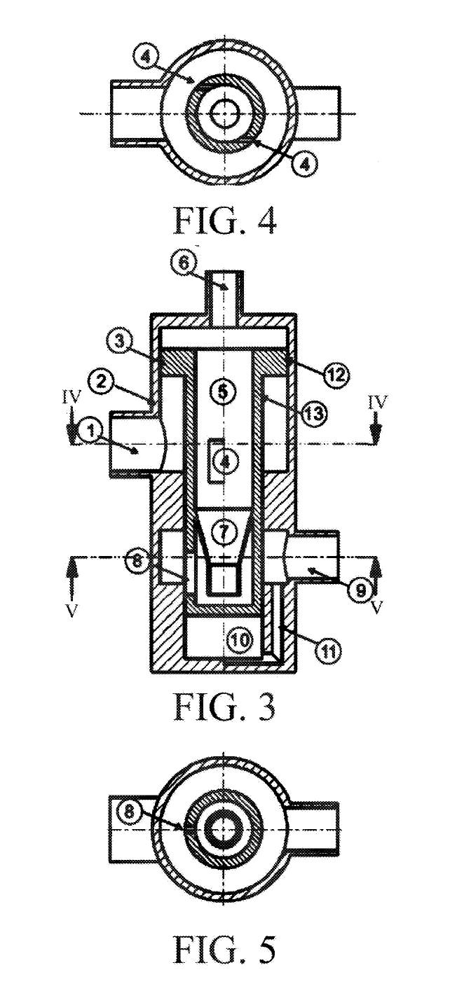

FIGS. 3 to 5 illustrate an embodiment of a condensate trap according to the invention. The condensate trap includes a casing 2 that has a liquid supply hole 1 located in a side wall and a liquid discharge hole 9 located in the side wall underneath the liquid supply hole, as well as a vapor vent hole 6 located in the upper side of the casing 2.

The casing 2 accommodates a cylindrical chamber 12 connecting to the liquid supply hole, in which chamber an expansion piston 3 can be moved. A hollow piston rod 13 is attached to the underside of the expansion piston. This piston rod has an outside diameter that is smaller than the outside diameter of the expansion piston, while the liquid supply hole 1 communicates with the chamber around the piston rod 13.

The wall of the piston rod 13 has throttling ports 4 which extend in tangential direction. Underneath the throttling ports 4 the piston rod has a siphon 7 which connects to the space 5 in the piston rod 13 via an open upper side and via an open lower side connects to a space in the piston rod above the bottom of the piston rod. A further throttling port 8 is located in the wall of the piston rod underneath the upper side of the siphon and as a result of an upward displacement of the expansion piston 3 can be made to communicate with the liquid discharge hole 9. The space in a further chamber 10 underneath the bottom of the piston rod communicates via a channel 11 with the liquid discharge hole 9.

The operation of the condensate trap will be described hereinafter. The medium enters the casing 2 through liquid supply hole 1. Via the annular chamber in the casing 2 around the expansion piston 3 the medium then flows to the tangential throttling ports 4. They may be slots or a plurality of vertically provided bores which have or do not have inserts or coating so as to cope with the cavitation at hand. In the tangential throttling ports 4 the medium is expanded to the pressure prevailing in a space 5 in the hollow piston rod 13 (mini cyclone). If the medium entering through the liquid supply hole 1 is pure liquid (condensate), flash gas will be developed after throttling. The tangential throttling ports 4 cause the expanded condensate to adopt a fast spin, so that liquid and flash gas are separated. The flash gas is discharged through the vapour discharge hole 6. The vapour discharge hole 6 may have the configuration shown in FIG. 3, but may also be put through to the space 5.

The liquid rotates downwards so as to expand via the siphon 7 and the further throttling port 8 to the exit pressure in the liquid discharge hole 9. The following pressures prevail on the expansion piston 3:

1. an entry pressure (condensing pressure) in the annular chamber around the piston rod and underneath the expansion piston 3,

2. an intermediate pressure (economizer pressure or expander feeding pressure) above the expansion piston 3 and above the bottom of the piston rod 13, and

3. an exit pressure (evaporator pressure) underneath the bottom of the piston rod 13.

The selection of the diameters of the expansion piston 3 and the piston rod 13 combined with the choice of the throttling ports 4 and the further throttling port 8 are determinant factors for the intermediate pressure obtained.

Now if gas comes along in lieu of pure liquid, the mass flow through the throttling ports 4 will strongly diminish as a result of choking. A little later this also happens in the further throttling port 8. Since the second throttling operation in the throttling port 8 can always process less mass flow than the first throttling operation in the throttling ports 4, the intermediate pressure will rise and force the expansion piston 3 to go down and thus reduce the throttling ports. Underneath the bottom of the piston rod 13 there is always the exit pressure that prevails via the channel 11. Now should the piston shut off both throttling ports, the pressure in the space 5 will drop and the expansion piston 3 will resume its upward movement.

The selection of the diameters of the expansion piston 3 and the piston rod 13 together with the selection of the size of the throttling ports 4 and the further throttling port 8 depends on:

1. the medium that is to be expanded; and

2. the prevailing entrance and exit pressure, as well as

3. the desired intermediate pressure, but also

4. whether or not the flash gas is discharged.

The novel thing about the condensate trap according to the invention is that:

1. It functions based on the principle that the mass flow significantly diminishes if gas instead of liquid is throttled. The physical phenomenon this is based on is called choked flow. The moment gas is allowed to pass, the intermediate pressure will rise and hence a force will be developed on the expansion piston so that it moves down and reduces the throttling ports;

2. it can be used as a gas supply for an expander or economizer port of a screw compressor;

3. it can be used as an “ordinary” condensate trap without discharge of flash gas;

4. it includes only a single moving part.

Though the invention has been described in the foregoing with reference to the drawings, it should be observed that the invention is not by any manner or means restricted to the embodiment shown in the drawings. The invention also extends to all embodiments deviating from the embodiment shown in the drawings within the spirit and scope defined by the appended claims.

What is claimed is:

1. A condensate trap, comprising:
a casing that is provided with a liquid supply hole located in a side wall of the casing and a liquid discharge hole located in the side wall of the casing underneath the liquid supply hole,
wherein the casing includes a cylindrical chamber connected with the liquid supply hole in which cylindrical chamber an expansion piston is movable which includes a hollow piston rod that is attached to a bottom side of the expansion piston,
wherein the piston rod has an outside diameter that is smaller than an outside diameter of the expansion piston,
wherein the liquid supply hole communicates with a chamber around the piston rod, and
wherein a wall of the piston rod includes at least one throttling port,
wherein a siphon is located in the piston rod underneath the at least one throttling port,
wherein the siphon communicates via an open upper side of the siphon with a first space in the piston rod above the open upper side of the siphon,
wherein the siphon communicates via an open lower side of the siphon with second a space in the piston rod above a bottom of the piston rod and below the open lower side of the siphon,
wherein a further throttling port is located in the wall of the piston rod underneath the open upper side of the siphon,
wherein the further throttling port communicates with the liquid discharge hole as a result of an upward displacement of the expansion piston, and
wherein a further chamber underneath the bottom of the piston rod communicates via a channel with the liquid discharge hole.

2. The condensate trap according to claim 1, wherein the at least one throttling port extends in a tangential direction of the piston rod.

3. The condensate trap according to claim 1, wherein a vapor discharge hole is located in an upper side of the casing.

4. The condensate trap according to claim 2, wherein a vapor discharge hole is located in an upper side of the casing.
